(19) United States
(12) Patent Application Publication
(10) Pub. No.: US 2021/0374784 A1
(43) Pub. Date: Dec. 2, 2021

(54) METHOD FOR INCORPORATING A PRODUCT IN A MULTI-LEVEL MARKETING SYSTEM AND ALLOWING USER TO MOTIVATE THEIR DOWNLINE

(71) Applicant: KwikClick, LLC, Murray, UT (US)

(72) Inventor: Fred Cooper, Framington, UT (US)

(21) Appl. No.: 17/332,891

(22) Filed: May 27, 2021

Related U.S. Application Data
(60) Provisional application No. 63/031,379, filed on May 28, 2020.

(51) Int. Cl. G06Q 30/02; G06Q 30/06

(52) U.S. Cl. CPC G06Q 30/0214; G06Q 30/0641; G06Q 30/0201; G06Q 30/0236

(57) ABSTRACT

The present disclosure is directed to a system and method that allows sellers of products to share promotional materials and communicate with other individuals in new ways. The sharing of promotional materials and commonality in product purchase histories may be used to enroll an individual product in a multilevel marketing (MLM) system. Members of an MLM organization may share promotional materials, send communications to numerous followers, or communicate with other members indirectly via a centralized computer or directly from one user device to another user device. Such methods allow a user to share information about products with related users based on the user's sharing a common purchase history. The sharing of this product related information may motivate users to purchase products based on the promotional materials including product insights or discounted prices regarding products offered for sale by an MLM organization.

### CROSS-REFERENCE TO RELATED APPLICATIONS

The present application claims priority benefit of U.S. provisional patent application 63/031,379 filed on May 28, 2020 the disclosure of which is incorporated by reference herein.

### BACKGROUND OF THE INVENTION

### Field of Invention

The present disclosure is generally related to multi-level marketing systems and methods. More specifically the present disclosure is directed to providing products and commissions to related users.

### Description of the Related Art

A Multilevel marketing (MLM) commission payment system is a sales methodology used by some direct sales companies, which may be used to encourage existing distributors to recruit new distributors who are paid a percentage of their recruits' sales. The recruits are “downline” of the distributors. The term “downline” is used to describe sellers of products that have been sponsored by a sponsor (i.e. a sponsee of the sponsor) to sell products. The term “upline” is used to refer to sellers of products that sponsored a given sponsee. As such, sponsors are distributors that are upline from their sponsees and sponsees are distributors that are downline from their sponsors. Distributors also make money through direct sales of products to customers. Amway, which sells health, beauty, and home care products, is an example of a well-known direct sales company that uses multilevel marketing.

Multilevel marketing (MLM) has been found to be a legitimate business sales methodology if participants receive something of value for their participation in an MLM organization. Even though Amway has a pyramid like structure where sponsors may receive more benefits than new recruits, Amway has been judged to be a legitimate organization because all participants receive the benefit of purchasing products at a competitive price. One problem with some MLM organizations referred to as “pyramid schemes” is when where new recruits do not receive any benefit based on just joining the MLM organization. One characteristic of a MLM “pyramid scheme” versus a legitimate MLM organization is that in a “pyramid scheme” new recruits receive benefits based primarily from signing up other new participants. Thus, money received from the new recruits only pays people above them or at the top of the organization rather than new recruits or others who actually perform work (e.g. the selling of products). As such, a “pyramid scheme” is also characterized by paying sponsors rather than individuals that perform the work. This is why “pyramid schemes” are illegal. These “pyramid schemes” involve taking advantage of people by pretending to be engaged in legitimate multilevel or network marketing activities, when their greater focus is on recruitment rather than on product sales.

One issue in determining the legitimacy of a multilevel marketing company is whether it sells its products primarily to consumers or to its members who must recruit new members to buy their products. If it is the former, the company is likely a legitimate multilevel marketer. If it is the latter, it could be an illegal pyramid scheme.

Each MLM company dictates its own specific financial compensation (or commission) plan for the payout of any earnings to their respective distributors. Compensation may be in the form of commissions that require a participant to enter a contract, pledging exclusivity in participation to the MLM company paying the commissions. Compensation plans of MLMs pay out to participants typically from two primary possible revenue streams. The first is paid out from commissions of sales made by the participants directly to their own retail customers. Retail customers are not tracked or known by the MLM company therefore MLM companies cannot substantiate either their existence or their sales volume individually or collectively. The second is paid out from commissions based upon the wholesale purchases made by other distributors below the participant who have recruited those other participants into the MLM; in the organizational hierarchy of MLMs, these participants are referred to as one's downline distributors.

MLM salespeople (distributors) are, therefore, expected to sell specific MLM company products directly to end-user retail consumers by means of relationship referrals and word of mouth marketing, but most importantly they are incentivized to recruit others to join the company's distribution chain as fellow salespeople so that these can become downline distributors.

Currently, no large financially successful MLM salesperson (distributor) can earn commissions of any significance or take full advantage of a commission compensation plan without personally recruiting others into their downline.

All MLM compensation companies permanently place new recruits in a tree structure for calculating commissions. Once placed, all sales made by that distributor from their personal purchases, or from new recruits they sponsor, generate commissions only for their sponsor and upline, regardless of all future products sold.

MLM companies offer goods or services offered specifically and exclusively by them. The large markups required for payment of commissions necessitate MLM companies to limit what products they can offer such that they will be financially indifferent regarding which product a distributor chooses to buy.

MLM companies currently have a “pay to play” requirement. Distributors are required to make monthly purchases, and/or meet downline group sales volumes to qualify for commissions. Thus the mode, median and average purchase size of a distributor in MLMs is virtually equal to this minimum qualification requirement and no greater.

Distributors only qualify for commissions if they have purchased a minimum threshold of products offered exclusively by the MLM company as set forth by an MLM company's commission program rules.

Currently, in order to join an MLM organization, there is an initiation fee, which may be a barrier against those that just wish to refer a single product they like. Current multi-level marketing (MLM) systems do not take full advantage of the internet and how consumers can influence other consumers to make purchases. Also, current MLM systems do not incorporate incentivizing users of a multilevel marketing system by offering a dynamic commission tree. In addition, there is no current MLM system that utilizes the money or funds dedicated to discounts or coupons to be reincorporated into a multilevel marketing system to incentive consumers to make purchases and advertise the product that they purchased. Thus, there is a need to provide users a method to join an MLM for free, being simple to use and allow the MLM commissions provided to purchasers, provided by the sellers to allow the purchasers to market the seller's products.

Currently, a company that is not utilizing an MLM structure for paying commissions for sales, cannot introduce one without developing a compensation plan specific for their company, following the methodology outlined above, and thus requiring them to become and subsequently adhere to applicable MLM law.

Currently, in order to join an MLM organization, there is an initiation fee, which may be a barrier against those that just wish to refer a single product they like. Current multi-level marketing (MLM) systems do not take full advantage of the internet and how consumers can influence other consumers to make purchases. Also, current MLM systems do not incorporate incentivizing users of a multilevel marketing system by offering a dynamic commission tree. In addition, there is no current MLM system that utilizes the money or funds dedicated to discounts or coupons to be reincorporated into a multilevel marketing system to incentive consumers to make purchases and advertise the product that they purchased. Thus, there is a need to provide users a method to join an MLM for free, being simple to use and allow the MLM commissions provided to purchasers, provided by the sellers to allow the purchasers to market the seller's products.

Current MLM organization's do not allow their members to share materials or communicate with other members based on relationships that are created based on member purchase histories. What are needed are new types of method and apparatus that allow MLM members to establish relationships and share information or communicate based on those relationships.

Further, there is currently no systematic way for consumers to promote any brand of preference outside the MLM industry and be paid in an MLM commission methodology without subjecting themselves to a contractual signup, initiation fee's, minimum recurring purchases sales, volume requirements, recruiting, exclusivity, and permanent tree placement (resulting in only upline distributors earning commissions).

### SUMMARY OF THE CLAIMED INVENTION

The presently claimed invention is directed to a method that may be implemented as a non-transitory computer-readable storage medium. In one embodiment a method includes receiving data associated with distributing materials that promote the sale of a product and sending promotional materials to user devices. These promotional materials may include or be associated with a code, where information may be received that includes the code and that identifies that the product was purchased by purchaser. This presently claimed method may also include identifying that a second user and a first user should receive a first set of commissions after the purchaser receives the product. This identification may be based on an evaluation of stored information that associates the code with the second user and that associates an initial code with the first user. This identification may have been performed after the second user and the first user previously purchased the product, and this identification may have been performed after the initial code was received with information that confirmed that the second user purchased the product. Another step that may be included in this method could include distributing the first set of commissions for receipt by the second user and by the first user after the purchaser receives the product.

An embodiment of the presently claimed invention may be implemented as a non-transitory computer-readable storage medium where a processor executes instructions out of a memory to perform a method consistent with the present disclosure. Here again this method may include receiving data associated with distributing materials that promote the sale of a product and sending promotional materials to user devices. These promotional materials may include or be associated with a code, where information may be received that includes the code and that identifies that the product was purchased by purchaser. This presently claimed method may also include identifying that a second user and a first user should receive a first set of commissions after the purchaser receives the product. This identification may have been performed after the second user and the first user previously purchased the product, and this identification may have been performed after the initial code was received with information that confirmed that the user purchased the product. Here again this method may include distributing the first set of commissions for receipt by the second user and by the first user after the purchaser receives the product.

### BRIEF DESCRIPTIONS OF THE DRAWINGS

FIG. 1 illustrates a system for multi-level marketing of products via a set of computing devices.

FIG. 2 illustrates a series of steps that may be performed at a user device when promotional information is shared with other user devices or when messages are sent to one or more user devices.

FIG. 3 illustrates a series of steps that may be performed at an administration computer that communicates with a user device performing the steps of FIG. 2

FIG. 4 illustrates steps 400 that may be performed by a computer at the third party network computer 160 of FIG. 1.

FIG. 5: Illustrates a computing system that may be used to implement an embodiment of the present invention.

### DETAILED DESCRIPTION

The present disclosure is directed to a system and method that allows sellers of products to share promotional materials and communicate with other individuals in new ways. The sharing of promotional materials and commonality in product purchase histories may be used to enroll an individual product in a multilevel marketing (MLM) system, where the product is offered and sold to a first purchaser—who can enroll as a registered MLM user. Members of an MLM organization may share promotional materials, send communications to numerous followers, or communicate with other members indirectly via a centralized computer or directly from one user device to another user device. Such methods allow a user to share information about products with related users based on the user's sharing a common purchase history. The sharing of this product related information may motivate users to purchase products based on the promotional materials including product insights or discounted prices regarding products offered for sale by an MLM organization

The present disclosure is also directed to a system and method to allow sellers of products to enroll an individual product in a multilevel marketing (MLM) type commission system (system), where a good or service (i.e. product) is offered by any vendor and sold to a first purchaser—who at the time of the purchase becomes a system user (or registered user/participant). This user has a code tied to the specific product(s) offered by the participating vendor. The code may be shared by this first user passively (by a purchase) or actively (by request) to a new buyer. The code share makes the new buyer a user of the system. The new user, like the first, will be allowed to purchase the product and provide advertisements to other purchasers. Commissions paid to respective downline purchasers for a single product may be limited by a preset number of defined levels. After a product is purchased, commissions are paid out to each respective purchaser according to the defined commission levels. A wave of creating and recreating users may be based on purchases and linking them together may be part of an iterative process. Remuneration on this specific product is paid to all or numerous users linked together in the system, each time a purchase is made. The links may be unique and fixed to each good or service being referred.

A registered MLM member or user may be provided a code tied to the purchased product such that the code may be passed onto followers of the registered user. The registered user may be allowed to advertise the product to a second purchaser and the second purchaser will be allowed to purchase the product and provide advertisements to other purchasers. Commissions paid to respective downline purchasers for a single product may be limited by a preset number of defined levels. After a product is purchased, commissions are paid out to each respective purchaser according to the defined commission levels.

The present disclosure is also directed to a system and method to allow sellers of products to enroll an individual product in a multilevel marketing (MLM) type commission system (system), where a good or service (i.e. product) is offered by any vendor and sold to a first purchaser—who at the time of the purchase becomes a system user (or registered user/participant). This user has a code tied to the specific product(s) offered by the participating vendor. The code may be shared by this first user passively (by a purchase) or actively to a new buyer, for example by providing a request to a user device of the new buyer. The code share makes the new buyer a user or member of the system. The new user, like the first, will be allowed to purchase the product and provide advertisements to other purchasers. Commissions paid to respective downline or upline purchasers for a single product may be limited by a preset number of defined levels. After a product is purchased, commissions are paid out to each respective purchaser according to the defined commission levels. A wave of creating and recreating users may be based on purchases and linking them together may be part of an iterative process that allows users to share links to product promotions or other marketing materials. Remuneration on this specific product is paid to all or numerous users linked together in the system, each time a purchase is made. The links may be unique and fixed to each good or service being referred. Links may be shared automatically or manually depending on the referrer's preference.

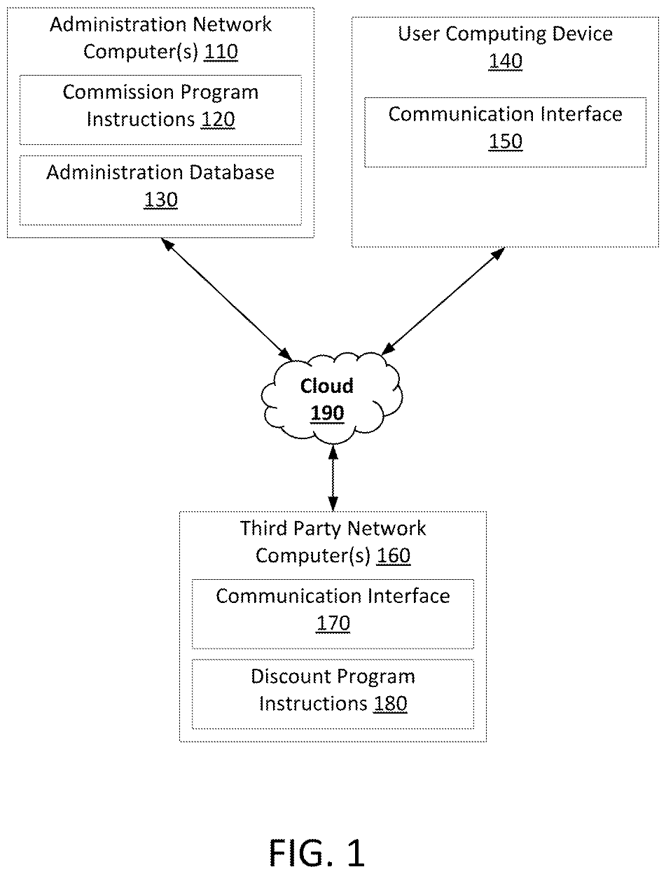

FIG. 1 illustrates a system for multi-level marketing of products via a set of computing devices. The multi-level marketing system 100 of FIG. 1 includes an administration computer or “administration network” computer 110, a user computing device 140 (user device), and a third party network computer 160. Each of the devices of FIG. 1, the administration network computer 110, the third party network computer 160, and user device 140 may communicate with each other via the communications network 190 such as the Internet or a cloud computing network.

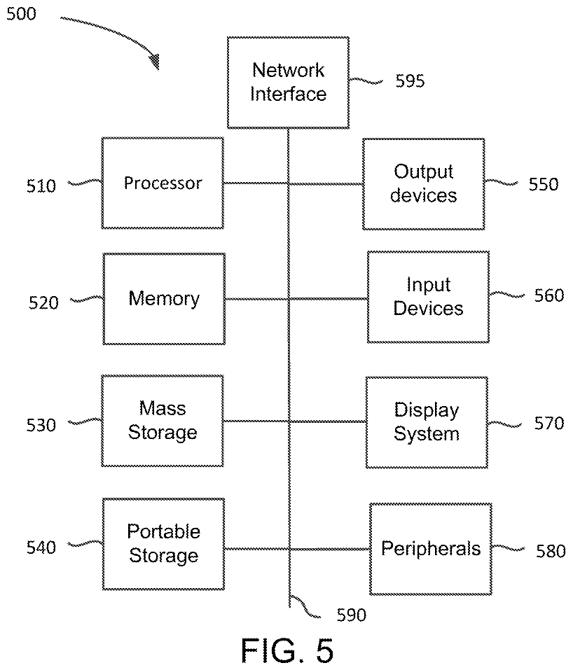

A memory, as shown in FIG. 5, at the administration network computer 110 may store commission program instructions 120 executed by a computer processor, and an administration database 130. User device 140 of FIG. 1 may be any user device such as a laptop, smartphone, tablet, computer, or smart speaker which may include a user device communication interface 150 which may be a network interface as shown in FIG. 5. The third party network computer 160 of FIG. 1 may include discount program instructions 180 executed by a computer processor, a memory, and a communication interface 150 which may be a network interface.

Use of the system may be as follows. A user connects a user device 140 to the communication network 190 via the user device communication interface 150. Communications may be sent through the communication network 190 the user device 140 may then connect with the third party network computer 160 via the third party network communication interface 170. A set of third party network discount program instructions 180 allow the user to purchase a product from the third party network computer 160 and apply a discount to the product if a user has a code. Confirmation of the purchase and the code are then sent from the third party network computer 160 to the administration network computer 110. If the user did enter a code, a set of administration network commission program instructions 120 will pay commission to at least another user that is associated with the code. A new code is then generated by the administration network 110 per the administration network commission program instructions 120. The new code is associated with the user of the user device 140. The commission and the newly generated code are stored in the administration network administration database 130. This process may allow a user to share promotional materials or messages with other users. User's may also be allowed to request to communicate with other users either directly from user device to user device or via a centralized computer. As mentioned above these shared promotional materials may motivate users or new prospective purchasers to purchase a product because of product insights or discounts included in the promotional materials.

Program code instructions of the administration network computer 110 may be organized as one or more software modules that include instructions for performing different functions. For example, a set of commission program instructions 120 may include base program instructions, advertising program instructions, calculation program instructions, and vendor program instructions. The administration network computer 110 may also access one or more databases, such as a compensation database that stores compensation data and a code database that stores program code or web link data, for example. The administration network computer 110 may accept sellers (third parties), where a “single product tree” multi-level marketing method is formed, comprising the steps of, providing at least one product, providing an MLM system with a seller's commission structure, and providing at least one seller of a product with its associated commission structure. The term “single product tree” refers to a unique structure for associating distributors of an MLM organization where products are used to identify relationships between distributors and commissions paid to related distributors. This “single product tree” structure allows for a particular user to be considered a sponsor or any other user based on that user sending promotions to other users to purchase a product that those other users were not previously associated with.

The administration network computer 110 may also provide a plurality of buyers/distributors, allow the at least one first seller to enroll a product to the MLM system, and allow at least a first buyer/distributor to purchase the product. Other functions that may be performed by the administration network computer 110 include allowing the at least the first buyer/distributor to advertise the product to other potential buyers/distributors and allowing at least a second buyer/distributor to buy the advertised product. Here the seller may set a commission structure for a product, may enroll the product into the MLM system, may allow the first, second and so on purchasers/distributors to purchase and advertise the product.

Once products have been enrolled with a commission structure, the administration network computer 110 may allow the purchasers/distributors to receive a commission based upon the seller's product commission structure. A distributor may refer to the non-salaried workforce selling the company's products or services. Here the earnings of the participants may be derived from a pyramid-shaped or binary compensation commission system. The term product may refer to articles or substances manufactured or refined for sale. Product may refer to an individual product, a line of products such as unique brand and model of drill, or a group of products such as all power tools. A service may refer to a system supplying a public need such as transport, communications, or utilities such as electricity or water.

A service which may be an act of dealing with a customer in a store, restaurant, or hotel by taking their orders, showing, or selling them goods. Additionally, a service which may be work that someone does or time that someone spends working for an organization, or a business that offers a particular type of help or work. The system 100 of FIG. 1 may distribute commissions according to an MLM tree or commission tree that is a payment structure in which commissions are given out at different percentages at different levels of the MLM tree, for example. In such a system distributors (users) that perform the sale or that are at a level that is “closer” to the distributor that performed the sale may receive larger commissions than distributors that are “farther” from the sale.

In another example, a first MLM distributor that performs a sale may receive a higher percentage than a second distributor that sponsored the first distributor, and a third distributor that signed up the second distributor may receive a lower commission than the commission received by the second distributor for the sale. Distributors in an MLM tree may be referred as “downline” or “upline” distributors depending on where different users rank on the MLM tree. For example, a first user that sponsors a second user is “upline” from the second user and the second user is “downline” from the first user in the MLM tree. Furthermore, any user/distributor that the second user sponsored would be considered downline from the second user and could be downline from the first user as well for a given MLM product tree. When a “single product tree” structure is used to identify commissions, users that are downline from the second user may not be downline from the first user based on the second user purchasing and advertising products not associated with the first user. When the first user purchases the product initially advertised by the second user, the second user may be considered upline of the first user after the first user purchases this product. Because of this, the second user is not relegated to always be downline from the first user just because the first user originally sponsored the second user to become an MLM distributor.

An MLM system which may be referred to as network marketing, may be a business model that depends on person-to-person sales by independent representatives, who may work from their home. A network marketing business may require the independent representatives to build a network of business partners or salespeople to assist with lead generation and closing sales. End of life of MLM tree may refer to the end of the MLM tree in which the commission tree may be restructured or eliminated. For example, further participants in the MLM may not receive a commission, the commission tree may “start up” (be reinitiated from a starting point) again, or the commission tree may be restructured in some other way. An existing MLM system may refer to currently existing or established companies that use the sales strategies to encourage existing distributors to recruit new distributors who are paid a percentage of their recruits' sales.

The administration network computer 110 may perform data security functions as well as functions associated with operation of an MLM algorithm that may calculate user compensation. Administration network computer 110 may be able to connect to a software application store, like the “Apple App Store,” where a program application can be downloaded from. Data security may refer to the process of protecting data from unauthorized access and data corruption throughout its lifecycle. Data security may include data encryption, tokenization, and key management practices that protect data across all applications and platforms. An MLM algorithm may refer to a calculation performed using a compensation decay rate to calculate the commissions for downline or upline participants.

The commission program instructions 120 of FIG. 1 may cause a computer processor in the administration network computer 110 to continuously poll for user data (e.g., data of a user who may be a product purchaser or product distributor) from another processor executing a set of discount program instructions 180 at a third party network computer 160. Once the processor of the administration network computer 110 receives the user data, commissions may be calculated using the commission program instructions 120 of FIG. 1. These commissions may be calculated based on data stored in an administration network compensation database. Downline and upline commissions for the other users (product purchasers/distributors) within the MLM tree may be paid. The administration network compensation database may be included within the administration database 130 of FIG. 1 or it may be a separate database accessible by the administration network computer 110. Alternatively, instead of the administration network computer 110 polling a third party network computer 160, the third party network computer 10 may send the user data to the administration network computer 110 after a sale has been made.

An upline may refer to the MLM distributors that recruits work for as salespeople to sell the products or services. A downline may refer to the recruits the MLM distributors are able to secure as participants in the MLM system. Downline MLM trees may go across country boundaries and commissions may be paid out for an MLM tree even though the participants in the MLM tree may not reside in the same country. The commissions may be calculated for the appropriate exchange rate to ensure participants are paid in their residing countries currency in the correct amount.

A processor executing the commission program instructions 120 of FIG. 1 may continuously poll for user data from the third party network computer 160. The administration network computer 110 may then receive the user data from the third party network computer 160. Then the administration network computer 110 may determine whether the user entered a code. If the user did enter a code, the processor at the administration network computer 110 may extract the code and then access the administration network compensation database to identify one or more different spheres of influence or potential product purchasers/distributors levels. Such a code may have been received from user device 140 based on user inputs. A sphere of influence for a given product may be associated with a chain of upline and downline distributors that sold a particular product, where each downline user may have been sponsored to sell the product by an upline user.

The processor at the administration network computer 110 may also associate a code for each of the different spheres of influence. The administration network computer 110 may then extract a corresponding commission for the code that was retrieved from in the administration network compensation database. The administration network computer 110 may then send the commission to the user (purchaser/distributor). The administration network computer 110 may track profits and payments as well as track taxes for users enrolled in the MLM system. The tracking of profits and payments may refer to the MLM system tracking the profits of the MLM and tracking the payments or commissions paid out to participants. The tracking of taxes may refer to tracking the commissions provided to participants for tax purposes. Then the administration network computer 110 may also compare the extracted code to data stored at an administration network code database a list of users and code sent to followers may be stored. This administration network code database may be the same database as the administration database 130 of FIG. 1 or it may be another database accessible by the administration network computer 110. The administration network computer 110 may extract a user ID and sphere of influence or potential purchaser/distributor by using the extracted code.

The administration network computer 110 may then compare the extracted sphere of influence or potential purchaser/distributor to data stored at the administration network compensation database. The administration network computer 110 may then use the extracted sphere of influence data to extract a corresponding commission from the administration network compensation database. The administration network computer 110 may then send the commission to an upline user. If the user did not enter a code, the administration network computer 110 may then initiate a set of administration network advertising program instructions.

The administration database 130 may store data received from various third parties (various sellers) that are part of a set of MLM trees. This data may contain an item ID, description of the item, an original cost of the item, a discount for the item, a cost of the item with the discount, a compensation plan decay rate, and a link to the item. An advertising link may refer to a link that directs a consumer to a product, service or good.

TABLE 1
Administration Database Data

| | | | |
|---|---|---|---|
| third party | Home Depot | Home Depot | Furniture Store |
| ID | 654123 | 789654 | 123789 |
| Item | Drill | Table Saw | Couch |
| Original Cost | $59.00 | $tem119.00 | $999.00 |
| Discount | 15% | 10% | 10% |
| Discount Cost | $50.15 | $107.10 | $899.10 |
| Compensation | 50% | 50% | 30% |
| Decay Rate | | | |
| Link | HDDrill654123 | HDTSaw789654 | FSC123789 |

Table 1 table displays data that may be stored at the administration database 130 of FIG. 1. When the administration network computer 110 receives item data from third party network computer 160 it creates a link for the item, stores the received data in the administration network administration database 130, and sends the created link back to the third party network computer 160. The administration network administration database 130 may be used to store data collected from various third parties that enrolled in the multi-level marketing system 100 of FIG. 1. The administration network administration database 130 may store the name of the third party, the ID for an item, a description of the item, the original cost of the item, the discount provided by the third party, the cost of the item with the discount, the compensation decay rate or how the downline commissions are calculated, and the link to the item.

The administration database 130 may store data that the administration network computer 110 may access when communicating events with the downlines and uplines, providing dynamic incentives or rewards for a product, distributing marketing materials, providing banking referrals, or distributing materials for suggestive selling, etc. Here, communicating events with downlines and uplines may refer to sending information relating to advertising events to participants of an MLM system. Dynamic incentives and rewards for a product may refer to incentives or rewards that are continuously updated for a product. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Banking referrals may refer to a structured flow of collecting and organizing referrals for banks. Businesses who have been unsuccessful in a credit application process with a bank may be asked for their permission to have their financial information passed to designated finance platforms who can contact the business in a regulated timeframe. Suggestive selling may refer to a sales technique where an employee asks a customer if they would like to include an additional purchase or recommends a product which might suit the client.

As mentioned above user device 140 may include a memory, a processor, and a communication interface 150. The processor of user device 140 may execute instructions out of the memory when a user of user device 140 registers as a member of an MLM organization. Other tasks that a user may perform on user device 140 could include, identifying or connecting with other user devices (e.g. follower user devices), preparing advertisement information to share with follower user devices, receiving advertisement information prepared by other users, accessing product promotions at the third party network computer 160, and purchasing products based on offerings received from the third party network computer 160. Each of the tasks performed by user device 140 may include sending and receiving communications with the administration network computer 110, the third party network computer 160, or other user devices. Promotions prepared at a particular user device may be shared with other user device via administration network computer 110, third party network computer 160, a social media network computer, or directly from one user device to another. User devices may also be required to download and install an application program from an application store, such as the “Apple App store” as part of a process for registering as a member of an MLM organization.

The user device communication interface 150 of FIG. 1 may send and receive data via a communication network 190 which may be a wired and/or a wireless network.

As discussed above the third party network computer 160 of FIG. 1 may include a computer processor a memory, and communication interface 170. This third party network computer 160 may be controlled by various third parties, such as retail stores (stores that sell product consumables, services, franchises, service networks, large box stores) or e-commerce sites that allow e-commerce sales. Such e-commerce sites may include an e-commerce shopping cart, that offer items to users at a discount, such as a product discount, in order to use the MLM system of FIG. 1. A franchise may refer to an authorization granted by a government or company to an individual or group enabling them to carry out specified commercial activities, e.g., providing a broadcasting service, or acting as an agent for a company's products. Product consumables may refer to goods by individuals and businesses that must be replaced regularly because they wear out or are used up. Service networks refer to a collection of people and information brought together on the internet to provide a specific service or achieve a common business objective, such as Angie's List. E-commerce sale may refer to sales of goods and services where the business takes place over the internet, an extra-net, Electronic Data Interchange (EDI), or other online system.

Payment may or may not be made online. Business in this context may be defined as an order placed by the buyer or price and terms of sale negotiated. E-commerce shopping cart may refer to a software used in E-commerce to assist visitors to make purchases online. Upon checkout, the software calculates the total of the order, including shipping and handling, taxes and other parameters the owner of the site has previously set. Retailer may refer to a person or business that sells goods to the public in relatively small quantities for use or consumption rather than for resale. Product discounts may refer to a reduce price or something being sold at a price lower than that item is normally sold for. It is a reduction to a basic price for a good or service. Large box stores may refer to a physically large retail establishment, usually part of a chain of stores, offers a variety of products to its customers. The term sometimes refers, by extension, to the company that operates the store, and which may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance.

The third party network communication interface 170 of FIG. 1 may send data and receive via a communication network 190 which may be a wired and/or a wireless network.

The third party network discount program instructions 180 of FIG. 1 may be executed by a computer processor after being initiated by a set of third party network base program instructions. These instructions may cause the processor at the third party network computer 160 to prompt user for a discount code and to compare a received code to data stored at a third party network third party database. When a code received from a user matches data stored at the databases, a discount for the selected item may be applied and an order for a product may be processed.

The communications network 190 of FIG. 1 may be the Internet or a cloud computing network. This communication network or any of the communication network interfaces 150 or 170 discussed herein may be a wired and/or a wireless network. Such a communication network, if wireless, which may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

Table 2 illustrates data that may be store at an administration network code database. This data may identify the codes given to the product purchasers/distributors (users) for the product purchasers/distributors (user) to pass to their potential purchasers/distributors to advertise or promote an item that a user has purchased. The administration network code may also cross-reference a user ID with an item ID, an item name, a sphere of influence (potential purchaser/distributor), and a code that may be shared with followers.

TABLE 2
Code Database Data

| | | | Sphere of Influence/ | |
|---|---|---|---|---|
| | | | potential | code for |
| user ID | ID | Item | purchaser/distributor | Followers |
| JS1234 | 654123 | Drill | First Participant | 654123-SOI2 |
| HY8569 | 654123 | Drill | Second Participant | 654123-SOI3 |
| TB4567 | 789654 | Table | First Participant | 897456-SOI2 |
| | | Saw | | |
| EL51346 | 789654 | Table | Second Participant | 897456-SOI3 |
| | | Saw | | |

A user device user database which may contain the user's (product purchasers/distributors) followers (sphere of influence) as well as the followers contact information for them to receive commissions on their purchases. A distributor contact list or followers may refer to the recruits or followers on social media that a distributor has secured to participate in their downline. The user device user database may include ratings and recommendations from the users. Rating and recommendation modules may refer to modules in which a company, entity, or person provides ratings and/or recommendations for products, goods, or services.

Table 3 displays data that may be stored at a user device user database. The data of table 3 cross-references user information with user follower information. The user device user database stores the user's ID, the followers user ID, codes provided to the followers, the follower's e-mail address, the follower's phone number, and the follower's address. The user device user database may store the follower's social media information such as user social media account information (Twitter, Instagram, Facebook, etc.). The user database may contain social media plug-ins for enhanced marketing or social media aggregators. Social media plug ins for enhanced marketing may refer to sharing content with other people through social media platforms, for example a share or like button. The user device user database may contain payment information such as bank accounts, credit card information, PayPal, Venmo, etc. A user ID or ID Enrollment may refer to a participant enrolling in an MLM product tree through an ID, which may be unique to each participant in the MLM system. Social media aggregators may refer to a tool that allows a person to collate posts and updates from many different social media feeds. It creates an organized view of social posts on a specific topic and are often used to display user-generated content on live social walls.

TABLE 3
User Database Data

| | | | |
|---|---|---|---|
| User ID | JS1234 | JS1234 | JS1234 |
| Follower ID | HY8569 | IT8527 | RW4569 |
| Follower Codes | 654123-SOI2 | 654123-SOI2 | 654123-SOI2 |
| Follower E-mail | HY8569@gmail.com | IT8527@yahoo.com | RW4569@gmail.com |
| Follower Phone | 781-654-8972 | 231-456-7891 | 654-987-3217 |
| Follower | 123 Main Street, | 58 Elm Street, | 96 2nd Ave, Salt |
| Address | Boston, MA | Burlington, VT | Lake City, UT |

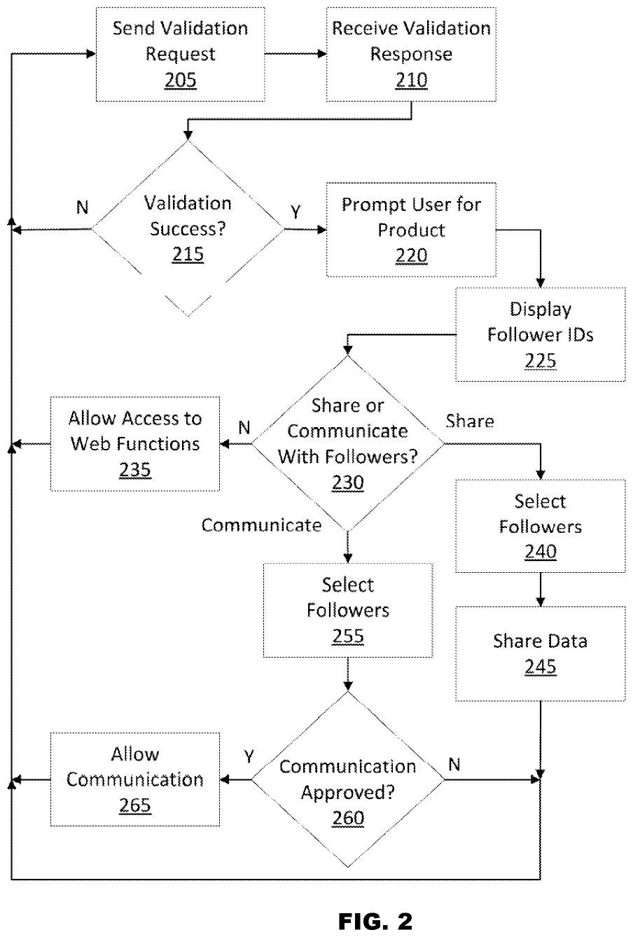

FIG. 2 illustrates a series of steps that may be performed at a user device when promotional information is shared with other user devices or when messages are sent to one or more user devices. FIG. 2 begins with step 205 where a validation request message is sent to an administration network computer. For example, this step may include user device 140 of FIG. 1 sending administration network computer 100 of FIG. 1 a request to identify whether a particular user is a member of a multilevel marketing organization. The message sent in step 205 may identify a user identifier (ID) and this message may include information that identifies the message as a request to validate that a subscription or membership status associated with the user ID is valid. This request message may also include login information used to authenticate a user associated with the user ID included in the validation request message. A user may be required to provide login information before certain functions at the user device can be initiated. For example, program code at a user device may require that a user successfully complete a login step before the validation request is sent to the administration computer in step 205. A user ID may also be tied to a machine (MAC) address or to other information that specifically identifies the user device (e.g. a device serial number or phone number). This information specific to a user device may be used by the administration computer as part of a user validation or subscription validation process. Furthermore, a hash of machine related information may be required as part of an authentication process.

The steps of FIG. 2 may be performed after a user of a user device makes a selection in a graphical user interface (GUI) of their user device to initiate an operation of a set of multilevel marketing communications program code at user device. After the communication program code is initiated, a user may make selections that allow them to share data or communicate with other users or followers. For example, a user may “prepare to send information to followers,” “open a downline viewer,” or to “access premium features” in the GUI. While FIG. 2 is primarily directed to sending data or communications to followers via follower (or “downline”) user devices, methods of the present disclosure may allow communications to be established with “upline” user devices (e.g. devices of the user's sponsor).

The administration computer after receiving the validation request message may check information stored in a memory or at a database that stores membership information. Such a membership database may store information that cross references user IDs with subscription status of various users. Table 4 illustrates data that may be included in a membership database. Note that table 4 includes a first column of user IDs, a second column of subscription status, and a third column of end date. Table 4 identifies that a use assigned user ID 47584 currently has an active subscription status and that user 47584 subscription will end on Aug. 31, 2020. Table 4 also identifies that a subscription assigned to user ID 64213 is currently inactive. As mentioned above, the validation of a user subscription may include checking a MAC address, device serial number, phone number, or other information specific to a particular user device.

TABLE 4
User Subscription Status

| User | Subscription | End |
|---|---|---|
| ID | Status | Date |
| 47584 | Active | 44074 |
| 27349 | Active | 44469 |
| 64123 | Inactive | 43861 |

When an administration computer receives a validation request message, that computer may access stored membership data to check to see whether a particular user ID is currently assigned an active status or not. The administration computer may then send a message to the user device that sent the validation request message indicating whether the user ID has a valid subscription or not. Next, in step 210 of FIG. 2, the validation response message may be received at the user device after which program flow may move to determination step 215. Step 215 may identify whether the response message indicates that the user associated with the relevant user ID has an active subscription or not. Determination step 215 may evaluate the response received in step 210 to identify whether a user of a user device has been successfully validated as an authorized user. When no, program flow may move back to step 205 or some other action may be taken that assists the user to change their subscription status, displays messages on a user interface that identifies that the user does not have an active subscription, or that allows a user to interact with an administration computer or other users to a limited degree.

When determination step 215 identifies that the user ID is associated with an active subscription or membership, program flow may move to step 220 that prompts a user to identify a product or that allows a user to select a product. Step 220 may include displaying a set of questions or selections to a user via user interface (e.g. a display) at the user device and may include receiving information from the user that identifies the product. A product selected or identified by the user in step 220 may be a product that the user wishes to purchase or share with other users. In certain instances, a user may not identify a product in step 220.

Step 220 may include receiving an identifier that identifies a product (a product ID) or may include receiving a selection of a product from a product list. This product list may identify products that the user of the user device previously purchased or distributed. Information provided to a user may in step 220 may identify a “stagnant commission tree” or “stagnant products” based on information that tracks a number of purchases for give products. When a number of purchases over a time period have not occurred or have not increased, information provided to the user in step 220 may identify these “stagnant” products. A “commission tree” may include a list of related users that are selling a particular product, where one user is “upline” of a set of follower or “downline” users. Each user that has bought and/or distributed a product first bought and/or distributed by an “upline” may be included in “commission tree,” where each of these user may share commissions according to a commission schedule. When sales associated with an established commission tree does not meet a threshold level or increase at a predetermined rate, that particular commission tree may be identified as being a “stagnant commission tree.” The growth of this commission tree may be identified by determining a number of new downline purchasers/distributors for this particular commission tree over a predetermined time period. In instances when the number of new purchasers/distributors do not grow at the predetermined rate over the predetermined time, one or user devices in the commission tree may be sent messages that prompt respective users to take action. In an instance when a number of sales for a product sold by a user's followers does not meet a threshold level over a threshold period of time (e.g. a week) a commission tree may be classified as being “stagnant.” Such thresholds could be defined by rules set by an administrator of an MLM organization.

After step 220 program flow may move to step 225 where a set of follower IDs may be displayed in a display of a user device. Each of the followers displayed may be part of a tree of users/followers or be considered as members of a “commission tree.” A given commission tree may include a plurality levels, where users at a higher level (i.e. upline users) may be sponsors of users at a lower level (i.e. downline users).

A mapping of such a tree of related users (or commission tree) may identify what is referred to as a user's “sphere of influence.” Such a tree may be created by placing followers at an appropriate level of a “sphere of influence” mapping. For example, such a tree may be a pyramid shape with an initial user at the top of the mapping and levels below this initial user may include a 1st sphere of influence level one step below the initial user, a second sphere of influence level below the 1st level (two steps below the initial, top, or primary user). Each subsequent level may include one or more users sponsored by one or more users located at a level of the pyramid above them (nearer to the top of the pyramid). As such, each user below the initial user, would be a follower of the initial user.

A “sphere of influence” mapping may also be described as a set of concentric circles, much like a target that includes a center circle and a set of rings formed by the set of circles. Here each set of rings would correspond to a next level, where the initial user is associated with the central circle of the mapping. A first ring would correspond to a first level of the sphere of influence, a second ring would correspond to a second level of the sphere of influence, and so on. Here again, users associated with rings further from the center of the mapping would be considered below users located at a ring closer to the center and all users in the mapping would be below the initial or primary user.

After step 225, program flow may move to step 230, that may identify whether the user wishes to share product information, offerings, or advice to their followers (via their respective user devices) or whether the user wishes to communicate with their followers. Note that program flow may move to step 235 when the user does not wish to share the product related information with their followers at this time, may move to step 240 when the user wishes to share product related information with their followers, or may move to step 255 when the user wishes to communicate with one or more of their followers.

When program flow moves to step 235, the user may be allowed to access website functions provided by an administration network computer. Website functions that may be accessed at the administration computer may allow the user to identify products that they wish to distribute, may allow the user to access website development tools, may allow the user to sponsor new users, or may allow a user to register as a follower of another user. After step 235, program flow may move back to step 205 where the user ID may be validated again.

When program flow moves to step 240, the user may select followers to share the product or product offering information with and that data may be shared with the user devices of those followers in step 245 of FIG. 2. The data shared with the user devices of the selected followers may include promotional materials generated by the user. These shared promotional materials may have been developed using website tools as discussed above or may have been developed at user device. After promotional materials have been developed or uploaded, they may be shared with the follower user devices. Information shared with follower devices may include a paragraph of text, recommendations that identify how to best sell a product, pictures of the product, a video of someone using the product, or advertisements from a company that sells or that manufactures the product. Such videos, pictures, other media data may be sent to downline users (i.e. followers) as part of a sales campaign.

Tools at an administration computer may allow user developed materials or messages provided by a user be delivered according to a schedule, once a week, for example. Messages shared with followers may include link to a blog that discusses the product. Such messages may remind followers to advertise a given product. In other instances, a user may configure messages to be sent automatically based on a follower's performance or whenever a follower makes a post relating to the product.

One type of automatic message may remind a follower to work harder after that follower has been identified as a low performing follower. Another type of automatic message may send a thank you message to a high performing follower or successful followers may be sent ideas that identify new advertising avenues to explore. In other instances, followers may be sent information that identifies new products that they could help sell. After step 245, program flow may move back to step 205 of FIG. 2.

When program flow moves to step 255, the user may be allowed to select followers to communicate with. Program flow may then move to determination step 260 that identifies whether communications with followers have been approved. Step 260 may include steps not illustrated in FIG. 2, these steps may include sending a request to communicate to a selected follower's user device. This may result in response being received that either authorizes communications or that denies communications with another user. When a response is received that indicates that the selected follower does not wish to communicate with the user or after a timeout period, program flow may move back to step 205, discussed above. Alternatively, certain users may have previously authorized communications with other users. For example, certain users may have sent a message to an administration computer identifying that the administration computer is authorized to share their contact information with other user devices in a “commission tree” that they belong. For example, a follower may have authorized the administration computer to send their phone number or email address to an upline user (i.e. a user that sponsored them to sell a given product) before a request to communicate with that follower has been received from a user device of that upline user. After a preauthorization message has been received, data identifying this preauthorization may be stored at a database accessible by the administration computer.

In the instance when determination step 260 identifies that a communication has been approved (e.g. by a follower), program flow may move to step 265, where communications between the follower and the user are allowed to occur. Steps 260 and 265 may include sharing contact information (e.g. a phone number, email address, or social media account information) such that communications between the user and a follower may be performed without being passed through the administration computer. Alternatively, communications between the user and the follower may be passed through the administration computer. After step 265, program flow may move back to step 205, where the user subscription status may once again be validated.

While FIG. 2 illustrates that followers are selected in a single operation before moving to either step 245 or step 260, program flow may move back to either step 240 or step 255 after data has been shared with a first set of followers or after a communication with a first follower has been completed. As such product information or communications may occur in either in a parallel fashion (one to many) or in a serial fashion (one to one).

While FIG. 2 illustrates steps that may be performed at a user device, some of the steps illustrated in FIG. 2 may be performed by an administration computer or with the assistance of an administration computer. For example, the user IDs displayed in step 225 may be collected from an administration computer each time step 225 is performed at a user device. Data shared with follower user devices or communications between a user device and a follower user device may be performed directly—without an administration computer acting as a device between the user device and the follower user device. Furthermore, instead of moving to step 205 from other steps (215, 235, 245, or 265) in FIG. 2, program flow could move to other steps not illustrated in FIG. 2, could move to another step of FIG. 2 (e.g. step 220), or execution of the program application performing the steps of FIG. 2 may be paused or ended.

As mentioned above, the sharing of product information or communications may be routed through the administration computer. In such instances, the respective user devices may only be aware of a user ID and information related to an actual physical user or use device may be hidden from other user devices. This could allow for added layers of security as one user device would not receive information that identifies user contact information (e.g. a phone number of a user device or an email address of a user), for example.

In yet other instances, some user devices of a MLM organization may store data that identifies a phone number, social media account, or email address of some users, where other user contact information is not stored at a particular user device. This type of hybrid structure may allow individuals that know each other personally to share information or communicate directly while allowing them to communicate with other users only via the administration computer. Once again, the forwarding of shared data or communications via the administration computer provides users with a greater level of security as compared to instances when data is shared directly between different user devices. As such, this hybrid structure may allow users with a choice to use direct communications, use forwarded communications, or to use a combination of both direct and forwarded communications.

Operation of user device downline program instructions may cause the user device 140 to continuously poll to receive the code and link from the administration network computer 110 to allow the purchaser/distributor to pass the code and link to the user's followers stored in the user device user database. Functioning of the downline program instructions may be as follows. The process begins with the user device 140 continuously polling for the code and the link from the administration network computer 110. The user device 140 receives the code and the link from the administration network computer 110. The user device 140 provides a selection of the first follower in the user device user database. The user device 140 extracts the followers contact information stored in the user device user database. Then the user device 140 sends the code and link to the follower's contact information. The code and link may be shared on social media sites, such as Twitter, Instagram, Facebook, etc. This may allow the user's followers to receive the code and link based on communications that use one or more of these social media accounts. The user device 140 may then determine if there are more followers remaining in the user device user database. If it is determined that there are more followers stored in the user device user database, the user device 140 selects the next user stored in the user device user database. If the user device 140 determines that there are no more followers remaining in the user device user database, then the process ends.

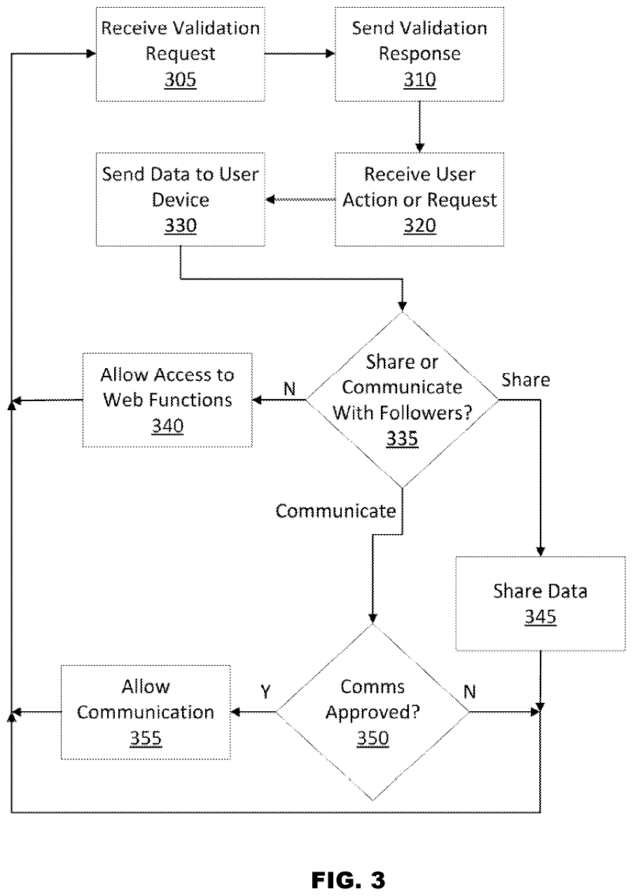

FIG. 3 illustrates a series of steps that may be performed at an administration computer that communicates with a user device performing the steps of FIG. 2. FIG. 3 begins with step 305 where a validation request is received from the user device. This validation request may cause the administration computer to compare user information with data of table 4, discussed above, when a current status of a user's subscription or membership with an MLM organization is validated. After the request has been received, a response may be sent to the user device in step 310 of FIG. 3. Next, in step 320 a user action or request may be received from the user device, this action or request may instruct the administration computer to send user data to the user device such that the user may perform other actions. After step 320, data may be sent data to the user device in step 330.

In certain instances, the steps of 320 and 330 may be performed iteratively. In such instances, program flow may allow a user to upload marketing materials or expands their follower network. After step 330, program flow may move to determination step 335 that identifies whether the user wishes to communicate with or share data with followers. When a user does not wish to share materials or communicate with their followers, program flow may move to step 340 where a user device may be allowed to access tools or web based functions. These tools or web functions may allow a user to generate marketing materials that they may share with their followers after those materials have been completed. When a user wishes to share materials or messages with their users, program flow may move to step 345 where materials or messages may be shared with their followers. This data may be shared by sending it to user devices of followers by the administration network computer 110 of FIG. 1. As mentioned above messages may be sent to user devices when sales associated with a commission tree have not met a threshold level, have not increased sufficiently over time, or sent automatically.

When determination step 335 identifies that a user wishes to communicate with other users, program flow may move to determination step 350 that identifies whether certain forms of communications have been approved. Determination step 350 may then identify whether a user of a user device is authorized to communicate with other user devices either directly or indirectly as discussed above in respect to FIG. 2. When communications have been approved, program flow may move to step 355, where communications between user devices may be allowed. As discussed previously, communications between user device may be performed directly based on sharing email addresses, phone numbers, or other contact information or communications may be passed through an administration network computer, such as computer 110 of FIG. 1, in a more secure way. When determination step identifies that communications are not approved or after steps 340, 345, or 355, program flow may move back to step 305 where additional validation requests may be received.

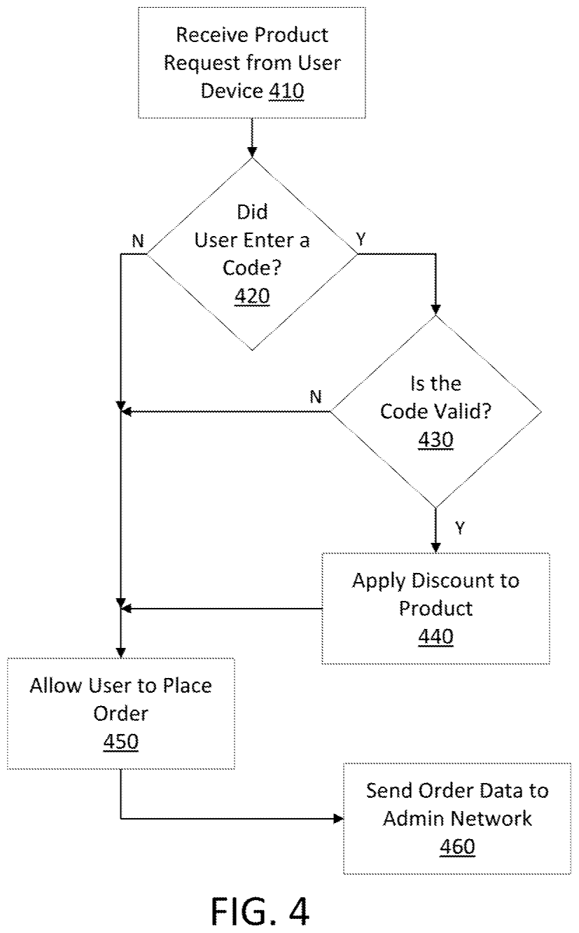

FIG. 4 illustrates steps 400 that may be performed by a computer at the third party network computer 160 of FIG. 1. FIG. 4 begins with step 410 wherein the third party network computer 160 receives a request from a user device 140 to purchase a product. This request may be facilitated by a public facing webpage, for example, an online store page for the third party retailer that controls the third party network computer 160 of FIG. 1. The third party network computer 160 then may identify if the user entered a code, at step 420. Here, the code may be entered prior to a request for purchase. For example, before checking out using an online shopping cart the user may be able to enter discount codes. If a code was entered, the third party network computer 160 may identify whether the code is recognized as a valid code for receiving a discount, at step 430 of FIG. 4.

The code may be retrieved from the administration network computer 110 via the third party network communication interface 170. Codes may be stored locally on the third party network computer 160 or in a third party network third party database accessible by the third party network computer. If the code is valid, the third party network computer 160 applies a discount to the item, at step 440. An amount associated with this discount may be retrieved by the administration network computer 110 via the third party network communication network interface 170. Discount amounts may be stored locally at a third party network database. The third party network computer 160 may then allow the user to finish placing the order for the item, at step 450 of FIG. 4. The third party network computer 160 may then send some or all the data on the purchase, including the discount code if one was provided, to the administration network computer 110, at step 460. Any or all these steps may also be facilitated by execution of different sets of program instructions that may include: third party network base program instructions and third party network administration program instructions.

A third party network computer 160 may execute administration program instructions to cause the third party network computer to connect to the administration network computer 110, send the data for the items to be purchased, receive a link from the administration network computer 110, store the link in a third party network database, and return to executing a set of base program instructions. The process may begin with the third party network computer 160 administration program instructions being initiated by the third party network base program instructions. The third party network 160 may connect to the administration network computer 110 and then the third party network computer 160 may send third party network database data to the administration network computer 110. Then the third party network computer 160 may store the link in the third party network third party database.

Operation of a third party network discount program instructions 180 may include extracting a link sent by the user device 140 and comparing it to data stored at the third party network third party database. This may result in the identification of a corresponding discount for a selected item. This process may include identifying whether a user entered a code or not, after which a discount is applied and the order is processed.

The process of applying a discount may begin by extracting the link received from the user. Then the third party network computer 160 may compare data included in the extracted link to data stored at the third party network database. The third party network computer 160 may then extract a corresponding discount from the third party network third party database. Then the third party network computer 160 may apply the extracted discount to the user's order. The third party network computer 160 may then determine if the user entered a code. If it is determined that the user did not enter a code the third party network computer 160 sends the user data to the administration network computer 110 without a code. If it is determined that the user entered a code the third party network computer 160 sends the code and the user data to the administration network computer 110. Next the third party network computer 160 may process the user's order.

A third party network third party database may store information about the items that may be purchased. This the third party network database may include local media for the product or service, where this local media may refer to the various types of media, such as photos, videos, text, sounds, haptics, online product descriptions, etc. for enhanced marketing.

Table 5 illustrates data that may be stored at a third party database. This data may include information about the items enrolled in the MLM system as well as a link created by execution of the administration network vendor program instructions. The third party network database may cross-reference an item ID, an item description, an original cost of the item, a discount provided by the third party for the item, a cost of the item with the discount, a compensation plan decay rate which the third party enters, and a link received from the administration network computer. The third party network third party database may include the rates of exchange for product returns, marketing materials, airline sky miles, etc. Product returns may refer to a process in which a customer or consumer takes previously purchased product, merchandise, or goods back to the retailer, and in turn receive a refund in the original form of payment, exchange for another item (identical or different), or a store credit.

The information about the product or service which may be advertisements to the network, or as seen on TV sales. Advertisements to the network may refer to the advertisement provided to the MLM system from the third party offering a product, good or service. These as seen on TV sales may refer to a generic nameplate for products advertised on television in the United States for direct response mail-order through a toll-free telephone number. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Airline sky miles may refer to a loyalty program offered by airlines and/or credit cards. Typically, consumers accumulate a set amount of miles based on how much is spent on a ticket or a credit card and are also known as frequent flyer miles or travel points.

TABLE 5
third party database Data

| | |
|---|---|
| ID | 654123 |
| Item | Drill |
| Original Cost | $59.00 |
| Discount | 15% |
| Discount Cost | $50.15 |
| Compensation | 50% |
| Decay Rate | |
| Link | HDDrill654123 |

FIG. 5 illustrates a computing system that may be used to implement an embodiment of the present invention. The computing system 500 of FIG. 5 includes one or more processors 510 and main memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 550, peripheral devices 580, and network interface 595.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 550 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a FLASH memory, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 550 may include a liquid crystal display (LCD), a plasma display, an organic light-emitting diode (OLED) display, an electronic ink display, a projector-based display, a holographic display, or another suitable display device. Display system 550 receives textual and graphical information and processes the information for output to the display device. The display system 550 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 580 may include any type of computer support device to add additional functionality to the computer system. For example, peripheral device(s) 580 may include a modem or a router.

Network interface 595 may include any form of computer interface of a computer, whether that be a wired network or a wireless interface. As such, network interface 595 may be an Ethernet network interface, a BlueTooth™ wireless interface, an 802.11 interface, or a cellular phone interface.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 500 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The functions performed in the processes and methods which may be implemented in differing order. Furthermore, the outlined steps and operations are only provided as examples, and some of the steps and operations which may be optional, combined into fewer steps and operations, or expanded into additional steps and operations without detracting from the essence of the disclosed embodiments.

What is claimed is:

1. A method for providing products, the method comprising:
receiving data associated with distributing promotional materials to user devices, the data received from a user device of a second user sponsored by a first user, wherein the promotional materials promote the sale of a product;
sending the promotional materials to at least one user device of the user devices, the promotional materials associated with the second user and with a code;
receiving information that includes the code and that identifies that the product was purchased by a purchaser associated with the at least one user device;
identifying that the second user and the first user should receive a first set of commissions after the purchaser receives the product, the identification based on an evaluation of stored information that associates the code with the second user and that associates an initial code with the first user, wherein the second user and the first user previously purchased the product and the initial code was received with a confirmation that the second user purchased the product; and
distributing the first set of commissions for receipt by the second user and by the first user after the purchaser receives the product.

2. The method of claim 1, further comprising:
classifying the purchaser as a third user;
associating the third user with a new code;
receiving additional data associated with distributing the promotional materials from the at least one user device; and
sending the promotional materials with the new code to an additional user device based on the receipt of the additional data.

3. The method of claim 2, further comprising:
updating the stored information to identify the association between the third user and the new code;
receiving information that includes the new code and that identifies that the product was purchased by a second purchaser associated with the additional user device;
identifying that third user, the second user, and the first user should receive compensation after the second purchaser receives the product, the identification based on an evaluation of the updated information; and
distributing the compensation for receipt by the third user, the second user, and the first user after the second purchaser receives the product.

4. The method of claim 2, wherein the code, the initial code and the new code authorize that a discount be applied to a purchase price of the product.

5. The method of claim 1 for providing products, the method comprising:
receiving data from a first user device of the user devices that identifies one or more user identifiers (IDs) of one or more users, wherein the first user ID is associated with a second product;
storing information that associates the first user ID with the one or more user IDs and the second product, wherein the stored information identifies commission levels between the first user and the one or more users;
receiving a message that authorizes that an offering for the second product should be shared with user devices of the one or more users based on the stored relationship information;
sending the message to the user devices of the one or more users; and
distributing a second set of commissions for receipt by at least the first user according to the commission levels after receiving a message indicating that at least one user of the one or more users has purchased and received the second product according to the product offering.

6. The method of claim 5, further comprising:
associating the first user ID and the second product with a first code; and
associating an additional user with the first user ID, the second product, and second code after the new user purchases the second product.

7. The method of claim 1, further comprising:
receiving a message to share with at least one user; and
sending the shared message to a computing device of the at least one user based on stored relationship information associating the first user with the at least one user and the product.

8. The method of claim 1, further comprising receiving a request from a first user device to establish direct communications with the second user.

9. The method of claim 8, further comprising:
sending the request to the user device of the second user based on the second user device being associated with the second user; and
receiving a message from the second user device that authorizes the direct communications between the first user device and the second user device; and
providing contact information to the first user device and to the second user device such that the first user and the second user can establish the direct communications via the first user device and the second user device based on the received authorization message.

10. The method of claim 8, further comprising:
accessing stored data that identifies that the user device of the second user has provided an authorization to share contact information with an upline user device;
identifying that the first user device is the upline user device; and
proving contact information to the first user device and to the second user device such that the first user and the second user can establish the direct communications via the first user device and the second user device according to the stored authorization data.

11. The method of claim 1, further comprising:
allowing a first user device to access a webpage provided by a computing device;
receiving a selection in the accessed webpage to initiate a function for generating a product offering; and
generating the product offering according to the selected function.

12. A non-transitory computer-readable storage medium having embodied thereon a program executable by a processor for implementing a method for providing products, the method comprising:
receiving data associated with distributing promotional materials to user devices, the data received from a user device of a second user sponsored by a first user, wherein the promotional materials promote the sale of a product;
sending the promotional materials to at least one user device of the user devices, the promotional materials associated with the second user and with a code;
receiving information that includes the code and that identifies that the product was purchased by a purchaser associated with the at least one user device;
identifying that the second user and the first user should receive a first set of commissions after the purchaser receives the product, the identification based on an evaluation of stored information that associates the code with the second user and that associates an initial code with the first user, wherein the second user and the first user previously purchased the product and the initial code was received with a confirmation that the second user purchased the product; and
distributing the first set of commissions for receipt by the second user and by the first user after the purchaser receives the product.

13. The non-transitory computer-readable storage medium of claim 12, further comprising:
classifying the purchaser as a third user;
associating the third user with a new code;
receiving additional data associated with distributing the promotional materials from the at least one user device; and
sending the promotional materials with the new code to an additional user device based on the receipt of the additional data.

14. The non-transitory computer-readable storage medium of claim 13, further comprising:
updating the stored information to identify the association between the third user and the new code;
receiving information that includes the new code and that identifies that the product was purchased by a second purchaser associated with the additional user device;
identifying that third user, the second user, and the first user should receive compensation after the second purchaser receives the product, the identification based on an evaluation of the updated information; and
distributing the compensation for receipt by the third user, the second user, and the first user after the second purchaser receives the product.

15. The non-transitory computer-readable storage medium of claim 13, wherein the code, the initial code and the new code authorize that a discount be applied to a purchase price of the product.

16. The non-transitory computer-readable storage medium of claim 12 for providing products, the method comprising:
receiving data from a first user device of the user devices that identifies one or more user identifiers (IDs) of one or more users, wherein the first user ID is associated with a second product;
storing information that associates the first user ID with the one or more user IDs and the product, wherein the stored information identifies commission levels between the first user and the one or more users;
receiving a message that authorizes that an offering for the second product should be shared with user devices of the one or more users based on the stored relationship information;
sending the message to the user devices of the one or more users; and
distributing a second set of commissions for receipt by at least the first user according to the commission levels after receiving a message indicating that at least one user of the one or more users has purchased and received the second product according to the product offering.

17. The non-transitory computer-readable storage medium of claim 16, further comprising:
associating the first user ID and the second product with a first code; and
associating an additional user with the first user ID, the second product, and second code after the new user purchases the second product.

18. The non-transitory computer-readable storage medium of claim 12, further comprising:
receiving a message to share with at least one user; and
sending the shared message to a computing device of the at least one user based on stored relationship information associating the first user with the at least one user and the product.

19. The non-transitory computer-readable storage medium of claim 12, further comprising receiving a request from a first user device to establish direct communications with a second user.

20. The non-transitory computer-readable storage medium of claim 19, further comprising:
sending the request to the user device of the second user based on the second user device being associated with the second user; and
receiving a message from the second user device that authorizes the direct communications between the first user device and the second user device; and
providing contact information to the first user device and to the second user device such that the first user and the second user can establish the direct communications via the first user device and the second user device based on the received authorization message.
